(19) United States
(12) Patent Application Publication
(10) Pub. No.: US 2026/0064565 A1
(43) Pub. Date: Mar. 5, 2026

(54) MECHANISMS FOR ASSESSING SERVICE RESILIENCE THROUGH FAULT INJECTIONS

(71) Applicant: Salesforce, Inc., San Francisco, CA (US)

(72) Inventor: Swaroop Jayanthi, Hyderabad (IN)

(21) Appl. No.: 18/819,130

(22) Filed: Aug. 29, 2024

(51) Int. Cl. G06F 11/36

(52) U.S. Cl. CPC G06F 11/3644; G06F 11/3612

(57) ABSTRACT

A computer system receives a fault injection payload that conforms to a template and identifies one or more faults to inject into a set of services of one or more target environments identified in the fault injection payload. The computer system performs a set of iterations to inject the one or more faults. A particular iteration includes the computer system identifying, for a particular fault, a fault injection system capable of injecting the particular fault. Based on the fault injection payload, the computer system generates and provides a payload ingestible by the identified fault injection system to cause the identified fault injection system to inject the fault. After performing the set of iterations to inject the one or more faults, the computer system performs a set of analyses to determine whether one or more anomalies occurred as a result of the one or more injected faults.

### BACKGROUND

### Technical Field

This disclosure relates generally to computer systems and, more specifically, to various mechanisms for assessing service resilience through fault injections.

### Description of the Related Art

Modern software products can be extremely complex. For example, many products are microservices-based, which means that the software is composed of small independent services that communicate over well-defined application programming interfaces (APIs). Each service can be designed to perform a specific function and can be independently developed, deployed, and scaled. For example, a customer relationship management (CRM) product may involve a storage service that stores data, a database service that accesses, manipulates, and stores data via the storage service, and a management service that provides various CRM-based functions and allows users to access their data via the database service. This microservices architecture approach can make software products easier to scale and faster to develop, enabling innovation and accelerating time-to-market for new features. But there are downsides to this approach. As one example, it can be difficult to ensure that all the services work together correctly as a given software product can be thousands of software services, and debugging issues across services can be more complex than in a monolithic system.

### BRIEF DESCRIPTION OF THE DRAWINGS

FIG. 1 is a block diagram illustrating example elements of a system capable of injecting faults into services and assessing the effects of the injected faults on the services, according to some embodiments.

FIG. 2 is a block diagram illustrating an example template that defines a format for fault injection payloads used for injecting faults into services, according to some embodiments.

FIG. 3 is a block diagram illustrating an orchestration platform collecting metric and topology information for services prior to injecting faults into the services, according to some embodiments.

FIG. 4A is a block diagram illustrating the orchestration platform injecting faults into services through injection platforms and injections agents, according to some embodiments.

FIG. 4B is a block diagram illustrating an injection requester communicating with the injection platforms to determine updated statuses for requested fault injections, according to some embodiments.

FIG. 5 is a block diagram illustrating analyzers of an analysis engine that perform analyses based on pre-injection information and post-injection information, according to some embodiments.

FIG. 6 is a flow diagram illustrating an example flow that pertains to injecting faults into services and assessing the effects of the injected faults on the services, according to some embodiments.

FIG. 7 is a flow diagram illustrating an example method that pertains to assessing the resilience of one or more services through fault injections, according to some embodiments.

FIG. 8 is a block diagram illustrating elements of a computer system for implementing various systems described in the present disclosure, according to some embodiments.

### DETAILED DESCRIPTION

Cloud computing platforms, such as Amazon Web Services®, Microsoft Azure®, etc., provide on-demand infrastructure (e.g., computing resources, storage resources, etc.) to clients that enables them to deploy software products that can be accessed by users without the clients having to actively manage that infrastructure. (As used herein, a “software product” refers to any collection of one or more software modules and can be comprised of multiple software services. A “module,” as used herein, refers to a set of software program instructions.) Part of the appeal of cloud computing platforms is their ability to support a large number of software services. This ability allows clients to build their own software product of arbitrary complexity, with a single software product potentially comprising hundreds of services. Understanding the performance characteristics of the services in the event of a failure is important in ensuring the high-availability of those services.

One approach to testing services is to manually write tests aimed at identifying defects and ensuring the services meet specified requirements. These tests may include unit tests that focus on individual components to ensure they work correctly and integration tests that verify that different modules or services interact as expected. But this approach has many drawbacks that include a high amount of human intervention (developers have to spend considerable time writing and maintaining their tests as the services are updated) and the large number of possible combinations and interactions between distributed services makes it difficult to account for all the cases. Another approach to testing services is through fault injection, which is a technique in which faults are injected into services (e.g., at run-time) to simulate error conditions in order to observe how those services respond. But there are various deficiencies in conventional fault injection designs. First, there is a general lack of analysis after a fault has been injected into a set of services to understand the behavior of those services, especially in a distributed context. For example, fault injection designs do not provide a mechanism to measure the mean time to recover for a set of services or a software product. Second, injecting faults into a set of services is tedious as it involves a high amount of human intervention (e.g., a developer has to manually extract metrics and logs and interpret them) and there is no approach to trigger the faults from a unified/centralized platform against target environments. This disclosure addresses, among other things, the technical problem of how to implement a mechanism (e.g., fault injection) to test software products in a manner that overcomes one or more of the above deficiencies.

The present disclosure describes various techniques for implementing a fault injection architecture that can inject faults into services deployed in different environments and perform various analyses pertaining to those services to identify outcomes (e.g., a time to recover) and anomalies (e.g., a service took too long to complete a task due to a failure in a different service that resulted from an injected fault). In various embodiments that are described below, the fault injection architecture includes an orchestration platform, a set of injection platforms, and a set of environments in which services execute. To inject a set of faults, the orchestration platform may receive a fault injection payload from a user that conforms to a template. This template may include key-value pairs for defining various pieces of information for injecting the faults, such as the faults to inject, the services and environments to be injected, the metrics to measure, trigger times at which to inject the faults, etc. Based on the values specified by the payload, in various embodiments, the orchestration platform collects pre-injection information, such as health metrics and topology information, for a set of services associated with the fault injection (e.g., all the services within the target environment). As an example, the orchestration platform may collect metrics that describe latency, throughput, and resource utilization of the targeted services.

After collecting that pre-injection information, the orchestration platform may perform an iterative process in which it iterates through the set of faults (identified in the fault injection payload) to inject them. In various embodiments, a given iteration of this iterative process for injecting a respective fault involves the orchestration platform identifying an injection system that is able to inject the fault into the appropriate service, providing a payload that is ingestible by the injection system to cause it to inject the fault, and caching a response from the injection system. After successfully injecting the set of faults, in various embodiments, the orchestration platform collects post-injection information for the relevant services and performs an analysis based on the pre-injection and post-injection information. This analysis may involve multiple sub-analyses, including an SQL analysis, a connection analysis, a lock analysis, a log analysis, and a correlation analysis. For example, the system may compare the query execution time of a database server before and after the disruption and determine the response time observed by an application server for a query. If the orchestration platform detects any anomaly during the overall analysis, then it may generate an alert for it. In various embodiments, the orchestration platform also measures the mean time to recover for one or more services associated with the set of injected faults and presents it to a user of the orchestration platform.

These techniques may be advantageous over prior approaches as they provide a fault injection architecture that can inject faults into services deployed in different environments and perform various analyses pertaining to the services to identify outcomes and anomalies without requiring a high amount of human intervention. That is, these techniques provide a centralized platform that is able to inject faults into services, extract metrics and logs associated with those services, and perform an extensive analysis based on those metrics and logs after a set of faults has been injected, all with minimal to no human intervention. As discussed, a software product often comprises hundreds of services that may depend on each other and thus the availability of a service can be crucial in maintaining the high availability of other services. By prioritizing the resilience and fault tolerance of the services through fault injection testing provided by the disclosed architecture, a developer may build a more robust and reliable infrastructure that can handle various types of failures and disruptions Additionally, regularly testing and refining of fault tolerance and resilience strategies using the disclosed architecture can help to identify and address vulnerabilities before they become significant problems. The disclosed techniques thus represent an improvement to computer systems and the field of software testing.

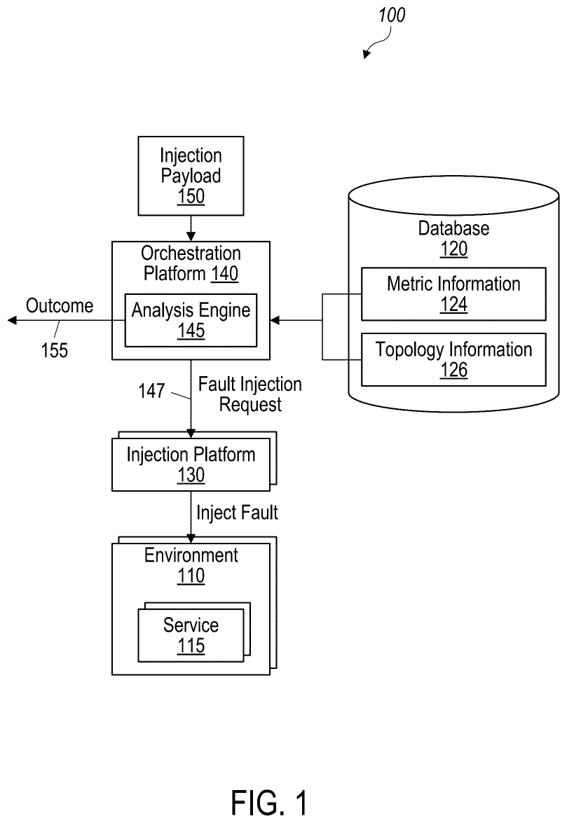

Turning now to FIG. 1, a block diagram of system 100 is shown. System 100 includes a set of components that may be implemented via hardware or a combination of hardware and software. In the illustrated embodiment, system 100 includes a set of environments 110 (with services 115), a database 120, a set of injection platforms 130, and an orchestration platform 140. Also as shown, database 120 includes metric information 124 and topology information 126, and orchestration platform 140 includes an analysis engine 145 and receives an injection payload 150. In some embodiments, system 100 is implemented differently than shown. For example, an injection platform 130 may be deployed within an environment 110. Furthermore, the number of components of system 100 may vary between embodiments. Thus, there can be more or fewer of each component than the number shown in FIG. 1—e.g., there may be multiple databases 120 (e.g., one storing metric information 124 and one storing topology information 126) and/or database 120 may be part of orchestration platform 140.

System 100, in various embodiments, implements a service platform (e.g., a customer relationship management (CRM) service platform) that allows users of that service to develop, run, and manage applications. System 100 may be a multi-tenant system that provides various functionality to users/tenants hosted by the multi-tenant system. Accordingly, system 100 may execute software routines from various, different users (e.g., providers and tenants of system 100) as well as provide code, web pages, and other data to users, databases (e.g., database 120), and other entities that are associated with system 100. In various embodiments, system 100 is implemented using a cloud infrastructure that is provided by a cloud provider—e.g., Amazon Web Services®. Thus, the components of system 100 may use the available cloud resources of the cloud infrastructure (e.g., computing resources, storage resources, etc.) to facilitate their operation. For example, program code that is executable to implement orchestration platform 140 may be stored on a non-transitory computer-readable medium of server-based hardware included in a datacenter of the cloud provider and executed in a virtual machine hosted on that hardware. Components of system 100 may be implemented without the assistance of a virtual machine or deployment technologies such as containerization. In some embodiments, system 100 is implemented using local or private infrastructure as opposed to a public cloud.

Environments 110, in various embodiments, are collections of resources available for implementing services 115 (e.g., a database service, a storage service, etc.). The resources may include hardware (e.g., central processing units, graphics processing units, storage disks, etc.), software (e.g., virtual machines (VMs), libraries, firewalls, etc.), or a combination thereof. For example, a VM in which service software modules execute can be deployed for an environment 110 by the cloud provider upon request, where that VM is instantiated using a node image. In various embodiments, a node image is a template having a software configuration (which can include an operating system) that is used to deploy an instance of a VM. An example of a node image is an Amazon Machine Image (AMI). Software for implementing services 115 may then be deployed in the VM.

As mentioned above, system 100 can be implemented using a cloud infrastructure. As such, environments 110 can correspond to at least a portion of the cloud infrastructure provided by a cloud provider and be made available to one or more tenants (e.g., government agencies, companies, individual users, etc.). For cases in which there are multiple tenants using a given environment 110, that environment 110 may provide isolation so that the data of one tenant is not exposed to other tenants without authorization. In various embodiments, environments 110 are a designated type of environment, such as a development environment, a test environment, or a production environment. Environments 110 may also be associated with a cloud zone. A cloud zone, in various embodiments, is an isolated location in a data center region from which public cloud services can originate and operate. The resources within a zone can be physically and logically separated from the resources of another zone such that failures in one zone, such as a power outage, do not affect the resources and operations occurring within the other zone in most cases. In some cases, a service 115 may be a distributed service that is deployed to an environment 110 that encompasses multiple cloud zones—e.g., database servers of a database service 115 may be distributed across multiple cloud zones for a production environment.

Services 115, in various embodiments, are services that are provided through software applications/modules, often distributed over the Internet. Examples of services 115 include an email service, a streaming service, a resource provisioning service (e.g., an Infrastructure as a Service), a platform service (e.g., a Platform as a Service), a web service (e.g., a retail website), and an online transaction processing service. In various embodiments, a set of services 115 can form a hierarchical structure in which a higher-level service 115 uses the functionality provided by a lower-level service 115. In many cases, the higher-level service 115 enables a yet higher-level service 115 to utilize or otherwise benefit from the functionality of the lower-level service 115 while hiding the complexity involved in interacting with the lower-level service 115. For example, a management service 115 may interact with a database service 115 to store its data using a storage service 115. In various embodiments, a service 115 implements (or is coupled to) a metric mechanism that tracks metrics of that service 115 and stores the metrics at database 120.

Database 120, in various embodiments, is a collection of information that is organized in a manner that allows for access, storage, and/or manipulation of that information. Database 120 may include supporting software (e.g., storage servers) that enables a database service 115 to carry out those operations (e.g., accessing, storing, etc.) on the information stored at database 120. In various embodiments, database 120 is implemented using a single or multiple storage devices that are connected together on a network (e.g., a storage attached network (SAN)) and configured to redundantly store information in order to prevent data loss. The storage devices may store data persistently and thus database 120 may serve as a persistent storage for system 100. Further, as discussed, components of system 100 may utilize the available cloud resources of a cloud infrastructure and thus the data of database 120 may be stored using a storage service provided by a cloud provider (e.g., Amazon S3®). In various embodiments, data that is written to database 120 by one service 115 is accessible to other services 115. As shown, database 120 stores metric information 124 and topology information 126.

Metric information 124, in various embodiments, is a collection of metrics that describe the state and/or performance of one or more services 115. Metric information 124 may describe system performance metrics (e.g., CPU usage, memory usage, disk I/O, etc.) for systems that are implementing services 115, application performance metrics (e.g., response time, error rate, throughput, etc.) for services 115, network metrics (e.g., bandwidth usage, packet loss, network latency, etc.), and event-based metrics (e.g., the time duration of specific events, the number of specific events, etc.). In various embodiments, metric information 124 also describes custom metrics configured by a user (e.g., heap size, database query performance, API calls, etc.). For example, a metric service 115 that tracks metrics for a database service 115 may be configured to track the average time to execute a query and the number of queries executed per second by the database service 115 and output the results under custom metrics. Metric information 124 may further describe user-experience metrics (e.g., page load time, user session duration, etc.) security metrics (e.g., failed login attempts, unauthorized access attempts, etc.), infrastructure metrics (e.g., server uptime, service availability, etc.), and test metrics. Metric information 124 may store any assortment of metrics for a service 115 that a user (e.g., a service provider) seeks to track for that service 115.

Topology information 126, in various embodiments, is information that describes the structure, organization, and relationships of components (e.g., services 115) in system 100. For example, topology information 126 may describe dependencies between a database server and a storage server. In various embodiments, topology information 126 is represented as a graph data structure that includes nodes interconnected by edges. A node may represent a component of system 100 while an edge may represent the direction and type of the relationship between that component and another component represented by another node. The types of relationships may include a “host” relationship, a “control” relationship, a “depend” relationship, a “consist of” relationship, and a “contained in” relationship. For example, a computer system may host a database server of a database service 115 that depends on a storage server of a storage service 115, and the database server and the storage server may be contained in a VM. These various components may be represented as different nodes in a graph that are interconnected by edges (e.g., a directional edge from the database server node to the storage server node is associated with a “depend” relationship, with the direction of the edge indicating that the database server depends on the storage server.). In various embodiments, topology information 126 is managed in part by a deployment system (e.g., Kubernetes®) that deploys components of services 115 for environments 110.

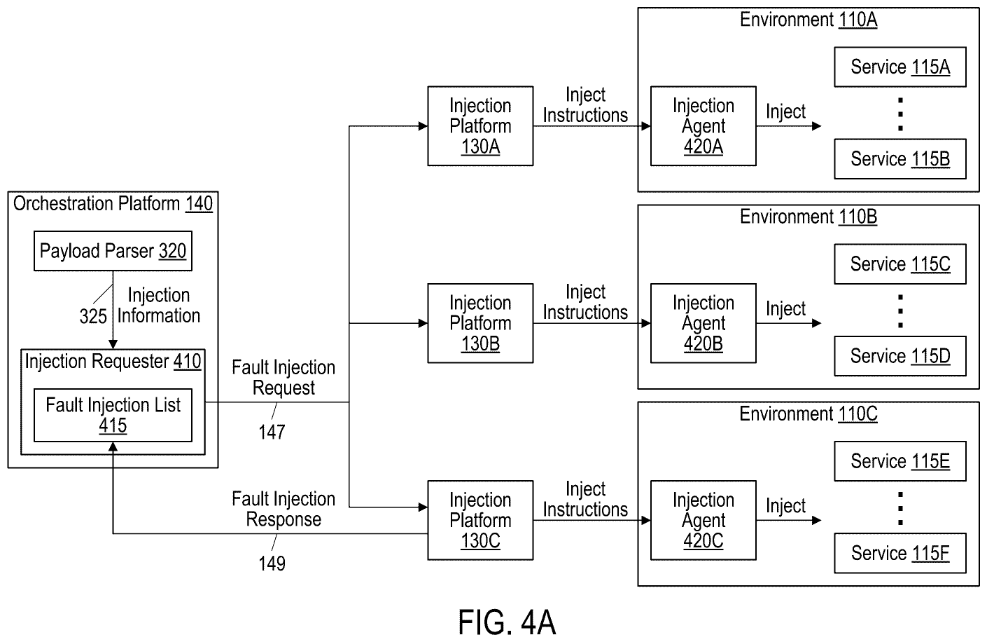

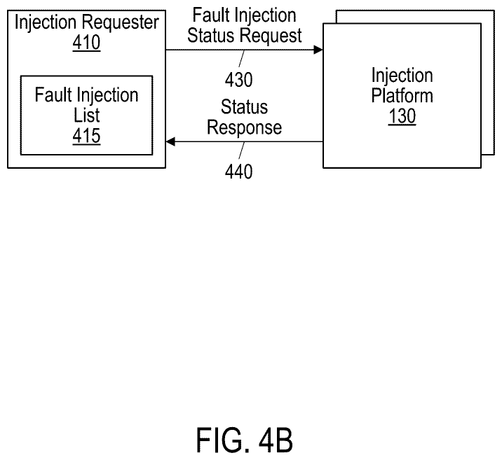

Injection platforms 130, in various embodiments, are software platforms that facilitate the injection of faults into components (e.g., services 115) in system 100. As services 115 may be deployed in different environment 110 and/or different cloud zones, there may be multiple injection platforms 130 in order to enable orchestration platform 140 to inject faults into those services 115. In various cases, there may be an injection platform 130 per environment 110 or per cloud zone, where a given injection platform 130 is able to inject faults into the components of its environment 110 or cloud zone. These injection platforms 130 may be different instances of the same fault injection software product or they may be instances of different fault injection software products. While not shown, injection platforms 130 may include or be associated with injection agents coupled to services 115 in one or more environments 110. Upon receiving a fault injection request 147 from orchestration platform 140 to inject one or more faults, a given injection platform 130 may communicate with the appropriate injection agents in order to inject the faults into the appropriate services 115. In various embodiments, an injection agent makes API calls to a service 115 (or a component that has influence over that service 115, such as an operating system) to invoke functions that cause faults to occur that may affect the service 115. Injection agents and the various interactions between injection platforms 130 and orchestration platform 140 are discussed in more detail with respect to FIGS. 4A and 4B.

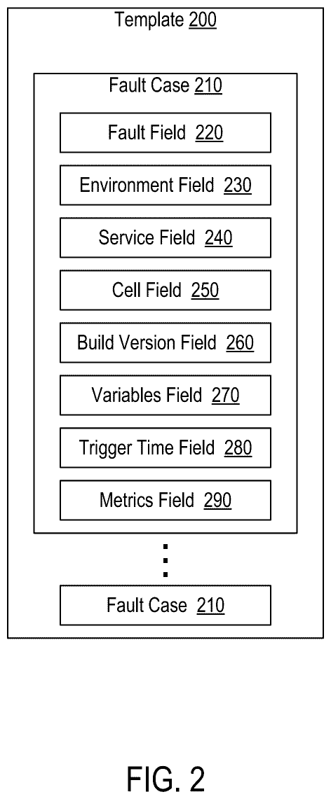

Orchestration platform 140, in various embodiments, is a unified software platform that orchestrates the injection of faults into components in system 100 and performs an analysis of the effects produced by injecting the faults to measure various characteristics (e.g., the time to recover for a service 115) and detect anomalies. Orchestration platform 140 may inject one or more faults upon receiving an injection payload 150 from, e.g., a user. Injection payload 150, in various embodiments, conforms to a template and includes a set of key-value pairs defining values for parameters of the template for injecting fault(s) into one or more target environments 110. Injection payload 150 may include information such as the fault(s) to inject, the identity of the service(s) 115 and target environment(s) 110, metrics to measure, etc. As an example, injection payload 150 may describe injecting a particular fault that crashes a set of database servers of a database service 115 while measuring the mean time to recover. The template that injection payloads 150 may conform to is discussed in greater detail with respect to FIG. 2.

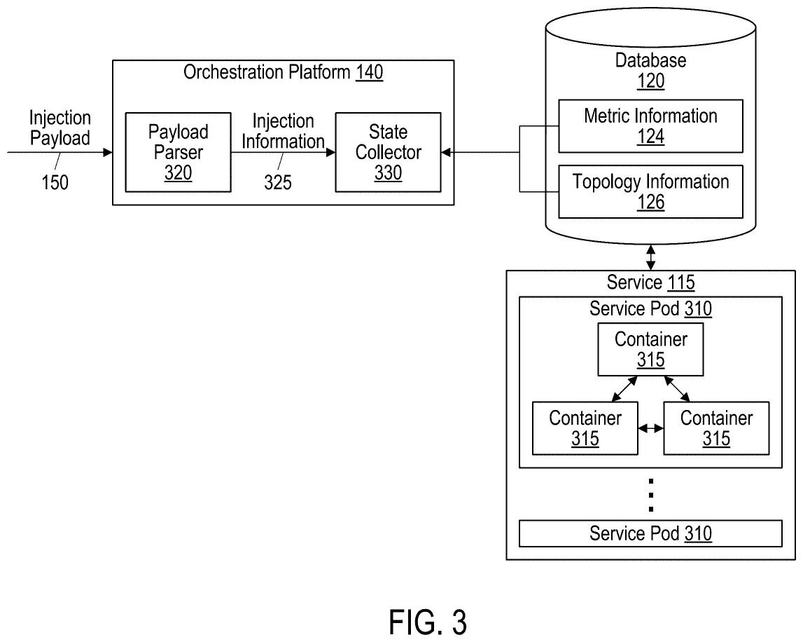

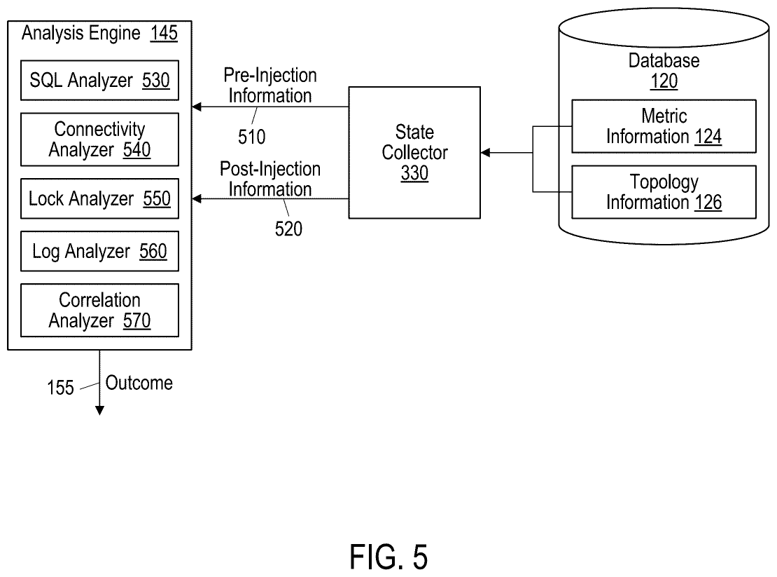

As a part of the process of injecting faults into services 115 and analyzing their affects, in various embodiments, orchestration platform 140 collects a pre-and post-injection snapshot of the state and performance of components associated with the faults. As discussed in greater detail with respect to FIGS. 3 and 5, orchestration platform 140 collects a pre-injection version of metric information 124 and topology information 126 and a post-injection version of metric information 124 and topology information 126. The collected information is then analyzed by analysis engine 145. Analysis engine 145, in various embodiments, is executable software that implements a set of analyses to measure characteristics and detect anomalies. The analyses can include an SQL analysis, a connection analysis, a lock analysis, a log analysis, and a correlation analysis, which are discussed in greater detail with respect to FIG. 5. Analysis engine 145 may publish the results of its analyses as outcome 155—outcome 155 may take the form of a set of records/row stored in a table. If analysis engine 145 detects an anomaly during the analyses, then outcome 155 may include an alert for it. Outcome 155 may also include measured values, such as the mean time to recover for a service 115. Based on outcome 155, a developer may determine the resiliency and fault tolerance of different services 115 and therefore may be able to build a more robust and reliable infrastructure that can handle various types of failures and disruptions.

Turning now to FIG. 2, a block diagram of an example template 200 is shown. In the illustrated embodiment, template 200 includes multiple fault cases 210. As shown a fault case 210 includes a fault field 220, an environment field 230, a service field 240, a cell field 250, a build version field 260, a variables field 270, a trigger time field 280, and a metrics field 290. In some embodiments, template 200 can be implemented differently than shown. For example, template 200 may include fewer or more fields (e.g., a description field).

Template 200, in various embodiments, defines fields for which injection payloads 150 provide values to inject faults into components of system 100. For example, template 200 may be a JSON template that defines key-value pairs and the data types (e.g., string, integer, etc.) of the values. An injection payload 150 conforms to template 200 by specifying values for the various fields of template 200. As discussed, an injection payload 150 may define one or more faults to inject. Accordingly, each specified fault case 210 may correspond to one of the faults, although a fault case 210 may specify multiple faults. In various embodiments, the ordering of fault cases 210 indicates the order in which the faults should be injected (expect for a fault case 210 that specifies a certain injection time in trigger time field 280). As shown, a fault case 210 includes fault field 220.

Fault field 220, in various embodiments, is used to identify the fault being injected for the fault case 210. In particular, a developer of a service 115 may define functions for inducing faults in their service 115—these functions may be accessible through API calls to allow them to be invoked by, e.g., an injection agent. The developer may register information about these functions or otherwise make them known to users of orchestration platform 140 so that those users can invoke them to test the service 115. Moreover, a function may also be defined for a component associated with a service 115, where the function injects a fault into the component to affect the service 115. As an example, a function may be defined that causes a network that is used by a service 115 to be disrupted in a particular manner in order to see how the service 115 responds. An injection payload 150 may thus specify, for fault field 220, an identifier value for the fault that can be used to determine which function to invoke in order to inject the fault to affect one or more components of system 100.

Environment field 230, in various embodiments, is used to identify the environment(s) 110 involved in the fault injection. For example, an injection payload 150 may specify a certain production environment 110. Environment field 230 may further be used to specify additional information, such as the public cloud (the substrate) and the cloud zone(s) of the public cloud involved in the fault injection. Service field 240, in various embodiments, is used to identify the service(s) 115 being injected with the identified fault(s)—more broadly, service field 240 may be used to identify any component of system 100. Cell field 250, in various embodiments, is used to identify the cell(s) of the service(s) 115 being injected. A cell may correspond to an instance of one or more subservices of a service 115. For example, a database service 115 may comprise multiple database server clusters, and a cell may correspond to a given one of those clusters. As another example, a service 115 might be implemented by multiple instances of a group of servers that comprises an application server and a database server. Cell field 250 may be used to identify a particular group. Accordingly, cell field 250 may allow for a more granular injection by allowing for a subcomponent of a service 115 to be specifically targeted.

Build version field 260, in various embodiments, is used to identify the build version of the service(s) 115 being injected with the identified fault(s). There can be different versions of a particular service 115 that are executing in environments 110 and thus an injection payload 150 may identify the particular version of that service 115 to inject. This may allow for a user of orchestration platform 140 to test and compare different versions of a service 115 (e.g., does a newer version recover slower than an older version of that service 115). Variables field 270, in various embodiments, is used to specify values for input variables used in injecting the fault. For example, a function used to throttle a processor may include an input variable that controls the amount to throttle. Accordingly, an injection payload 150 may specify a value of that input variable via variables field 270. Variables field 270 may also be used to specify values for one or more configurable variables, including a namespace variable, that affect an injection of the fault(s).

Trigger time field 280, in various embodiments, is used to indicate a time at which to inject the fault(s) of the fault case 210. In various cases, an injection payload 150 may specify a specific date and time; in some cases, it may specify a time delay indicative how long to wait before injecting the faults. But if an injection payload 150 does not specify a value for trigger time field 280, then orchestration platform 140 may proceed to inject the faults of the fault case 210 without waiting for a particular time. That is, orchestration platform 140 may provide an ingestible payload to the appropriate injection platform 130 to inject a particular fault without waiting until an injection time in response to determining that the corresponding fault injection payload 150 does not specify an injection time at which to inject that particular fault into a set of services 115. Metrics field 290, in various embodiments, is used to identify metrics to track as part of the injection and analysis process or metrics to exclude. As an example, a user may wish to track query execution time for a database service 115 and thus may identify that metric in their fault injection payload 150.

Template 200 may include other fields than those shown. For example, template 200 may include a parallel injection field that can be used to indicate whether the faults should be injected in parallel, a description field that can be used to provide a brief description for a fault case 210, a scope field that can be used to define the scope of a fault case 210, and an injection platform field that can be to identify a particular injection platform 130, although the relevant injection platform 130 may be determined from another field, such as environment field 230, in some embodiments.

Turning now to FIG. 3, a block diagram of orchestration platform 140 collecting a pre-injection version of metric information 124 and topology information 126 is shown. In the illustrated embodiment, there is a service 115, database 120, and orchestration platform 140. As shown, service 115 includes multiple service pods 310, and a service pod 310 includes multiple containers 315. Also as shown, orchestration platform 140 includes a payload parser 320 and a state collector 330, and database 120 includes metric information 124 and topology information 126. The illustrated embodiment may be implemented differently than shown. For example, state collector 330 may collect information from multiple databases 120 (e.g., one that stores metric information 124 and one that stores topology information 126).

In various embodiments, services 115 are implemented via services pods 310. A service pod 310, in various embodiments, is a set of application containers 315, with shared resources (e.g., storage resources), and is associated with a specification for executing those application containers 315. A container 315, in various embodiments, is an executable package of software that includes a software application and accompanying dependencies (e.g., system libraries and settings) needed in executing that software application. Containers 315 may be designed to be portable and consistent across various environments 110, ensuring that its software application executes reliably regardless of where it is deployed.

Service pods 310 may be deployed using a large-scale deployment platform, such as Kubernetes. Once a VM has been deployed and becomes an available resource to Kubernetes, Kubernetes may deploy a requested service pod 310 on that VM. Deploying a service pod 310 onto a VM may involve Kubernetes communicating with an agent residing on that VM, where the agent triggers the execution of the containerized applications of that pod 310—Kubernetes might use a control plane that can automatically handle the scheduling of pods 310 on VMs of a cluster included in an environment 110. In various embodiments, a VM can support multiple pods 310, and thus Kubernetes may deploy multiple pods 310 to the same VM. While pods 310 are discussed, in some embodiments, the software applications can be installed on a VM (or a physical computer) and executed without the use of containerization or a deployment platform.

In many cases, a service pod 310 includes a primary container 315 and multiple sidecar containers 315. The sidecar containers 315 may be used to enhance or extend the functionality of the primary container 315 by providing additional services, or functionality such as logging, monitoring, security, or data synchronization, without directly altering the primary application code. For example, a service pod 310 may have a primary container 315 that implements a web application and a sidecar container 315 that implements a local webserver required by that web application. In various cases, a service pod 310 includes one or more sidecar containers 315 having a monitoring software application that collects telemetry data (e.g., metrics, logs, etc.) from various components (e.g., other containers 315, its VM, etc.) and stores the collected data in database 120. For example, a sidecar container 315 may implement at least a portion of the Salesforce® Argus platform, which is a time-series monitoring and alerting platform that can collect various metrics data from various sources. Accordingly, that platform may produce at least a portion of metric information 124—that is, the platform may collect various, specified metrics and store them at database 120 as part of metric information 124. As another example, a sidecar container 315 may implement at least a portion of the Splunk® tool, which collects and transforms raw metrics, traces, and logs into actionable insights in the form of dashboards, visualizations, and alerts. Accordingly, that tool may also produce at least a portion of metric information 124—e.g., metric information 124 may include Splunk log data.

As shown in FIG. 3, orchestration platform 140 receives an injection payload 150, which it parses using payload parser 320. Payload parser 320, in various embodiments, is executable software that parses injection payloads 150 in order to determine what faults are being injected along with other information, which may include where to inject those faults, what metrics to track, etc. This parsing may include validating the received injection payload 150 to determine that any required fields have been completed and ensuring that correct syntax has been used. If the received injection payload 150 fails the validation process, then payload parser 320 may return an error response. This parsing may further include performing a syntax analysis of the clauses specified in the received injection payload 150 and assembling injection information 325. In various embodiments, injection information 325 includes various pieces of information about the fault cases 210 defined in the received injection payload 150, such as the faults being injected, the services 115 and environments 110 involved, any trigger times, metrics to collect, etc. Injection information 325 is provided to state collector 330 so that it may collect relevant information for any analyses performed after injecting the faults.

State collector 330, in various embodiments, is executable software that collects pre-injection and post-injection information from database 120 based on injection information 325. The collected information includes at least a portion of metric information 124 and/or a portion of topology information 126, in various embodiments. For example, injection information 325 may identify the environments 110 involved in the fault injections and thus state collector 330 may collect a portion of topology information 126 that describes the topology of components in those environments 110. As another example, injection information 325 may identify the services 115 involved in the fault injections and thus state collector 330 may collect a portion of metric information 124 that describes metrics associated with the services 115. Accordingly, state collector 330 may thus collect any or all portions of topology information 126 and metric information 124 that are relevant to the analyses being performed for the fault injections. In various embodiments, state collector 330 performs an initial collection of information (the pre-injection information) before the faults are injected and a subsequent collection of information (the post-injection information) after the faults are injected so that differences between the pre-injection and post-injection information may be used to determine the effects resulting from the injected faults, as discussed in more detail with respect to FIG. 5.

Turning now to FIG. 4A, a block diagram of orchestration platform 140 injecting faults into services 115 through injection platforms 130 and injections agents 420 is shown. In the illustrated embodiment, there is orchestration platform 140, injection platforms 130A-C, and environments 110A-C. As depicted, orchestration platform 140 includes payload parser 320 and an injection requester 410 having a fault injection list 415. Also as depicted, environments 110A-C include injection agents 420A-C, respectively, as well as services 115A-B, 115C-D, and 115 E-F, respectively. The illustrated embodiment may be implemented differently than shown. For example, an injection platform 130 may send injection instructions to two or more environments 110, and/or injection platforms 130A-C may be included within environments 110A-C, respectively.

Injection requester 410, in various embodiments, is executable software that triggers fault injections by issuing one or more fault injection requests 147 to injection platforms 130A-C based on injection information 325 (received from payload parser 320 as shown in FIG. 4A). In various cases, injection requester 410 may perform an iterative process in which it iterates through the set of requested faults to inject them. In various embodiments, a given iteration of this iterative process involves identifying an injection system 130 that is able to inject the fault (of the iteration) into the appropriate service 115, providing a fault injection request 147 to that injection system 130 with a payload that is ingestible by that injection system 130 to cause it to inject the fault, and caching a fault injection response 149 returned by the injection system 130.

As discussed, there may be an injection platform 130 per environment 110 or per cloud zone, where a given injection platform 130 is able to inject faults into the components of its environment 110 or cloud zone. Accordingly, in order to inject a fault, injection requester 410 initially determines an injection platform 130 for injecting the fault based on the services 115 and/or the environments 110 associated with the fault. For example, an injection payload 150 may specify a fault be injected into service 115A of environment 110A. Accordingly, injection requester 410 determines that injection platform 130A is responsible for environment 110A and thus provides a fault injection request 147 to injection platform 130A to inject the fault. In some cases, an injection payload 150 may request a fault be injected to multiple environments 110 and thus injection requester 410 may interact with multiple injection platforms 130.

In various embodiments, injection requester 410 maintains a fault injection list 415 that describes one or more requested fault injections and their respective status (e.g., completed). After issuing a fault injection request 147 to an injection platform 130, injection requester 410 may receive a fault injection response 149 from that injection platform 130 that indicates that the injection platform 130 will proceed to inject the fault or it issued inject instructions. Based on the fault injection response 149, injection requester 410 may add the fault to fault injection list 415 with a status indicating that the fault is being injected. As discussed in more detail with respect to FIG. 4B, injection requester 410 may later follow up with the injection platform 130 to determine whether the fault was successfully injected. In some embodiments, the received fault injection response 149 indicates that the fault was injected instead of indicating that the fault being injected. After receiving a fault injection response 149, injection requester 410 may then proceed to the next iteration in the iterative process to inject the next fault. In some cases, an injection payload 150 may specify faults to inject in parallel, and thus injection requester 410 may inject those faults in parallel instead of iteratively.

Upon receiving a fault injection request 147, an injection platform 130 may issue inject instructions to an injection agent 420 within the associated environment 110 to inject the fault into the targeted service(s) 115 (or components—e.g., a VM). Injection agents 420, in various embodiments, are executable software that injects a fault by, e.g., making an API call to invoke a function that implements the fault. While injection agents 420A-C are shown separately from services 115A-F, in some embodiments, injection agents 420A-C are implemented in sidecar containers 315 within those services 115. As an example, there may be a sidecar container 315 for service 115A that implements injection agent 420A and a sidecar container 315 for service 115B that implements another injection agent 420—thus there may be multiple injection agents 420 in the same environment 110. Upon receiving inject instructions, an injection agent 420 may identify a function that can be used to inject the requested fault and invoke that function. After attempting to inject a fault, that injection agent 420 may return a response to its injection system 130 that indicates whether the fault was successfully injected.

Faults may be injected at different granularities. In some cases, a fault may be injected at the container level where one or more specific containers 315 are targeted. In some cases, a fault may be injected at the pod level where one or more specific pods 310 are targeted—e.g., a healthy pod 310 may be deleted. In some cases, a fault may be injected at the service level where one or more specific services 115 are targeted. In some cases, a fault may be injected at the environment level where one or more specific environments 110 are targeted—e.g., a specific configuration of an environment 110 may be changed to observe how the components in the environment 110 respond. In some cases, a fault may be injected at the hardware level—e.g., throttle a CPU unit. In some cases, a fault may be injected at the cloud zone level—e.g., block traffic from/to a random cloud zone with respect to other cloud zones to observe how a service 115 distributed across those cloud zones responds. As another example, all VMs within a particular cloud zone allocated for a provider of system 100 may be terminated.

Turning now to FIG. 4B, a block diagram of injection requester 410 communicating with injection platforms 130 to determine updated statuses for requested fault injections. In the illustrated embodiment, injection requester 410 includes fault injection list 415. The illustrated embodiment may be implemented differently than shown. For example, injection requester 410 may receive status responses 440 from injection platforms 130 without sending fault injection status requests 430.

After issuing a fault injection request 147 to an injection platform 130 and receiving a fault injection response 149, in various embodiments, injection requester 410 follows up (e.g., after a period of time) with that injection platform 130 to determine whether the requested fault was successfully injected. In some instances, injection requester 410 may follow up with the appropriate injection platforms 130 after issuing fault injection requests 147 for all faults that are associated with a particular fault injection payload 150. Injection requester 410 may iterate through fault injection list 415 and issue a fault injection status request 430 to the appropriate injection platform 130 to request the status for each fault injection. An injection platform 130 may return a status response 440 to injection requester 410 that indicates that the fault injection is complete or that it failed. If a fault injection failed, in some embodiments, injection requester 410 reattempts to inject the fault by issuing another fault injection request 147 to the injection platform 130 associated with that fault. After updating the statuses or after determining that all faults have successfully been injected, orchestration platform 140 may then proceed to perform one or more analyses.

Turning now to FIG. 5, a block diagram of analyzers of analysis engine 145 that perform analyses based on pre-injection information 510 and post-injection information 520 is shown. In the illustrated embodiment, there is database 120, analysis engine 145, and state collector 330. Also as shown, database 120 includes metric information 124 and topology information 126, and analysis engine 145 includes a SQL analyzer 530, a connectivity analyzer 540, a lock analyzer 550, a log analyzer 560, and a correlation analyzer 570. The illustrated embodiment may be implemented differently than shown—e.g., analysis engine 145 may include a . . .

As shown, state collector 330 provides pre-injection information 510 and post-injection information 520 to analysis engine 145. Pre-injection information 510 may include at least a portion of metric information 124 and/or topology information 126 generated before a set of faults were injected, and post-injection information 520 may include at least a portion of metric information 124 and/or topology information 126 generated after the set of faults were injected. In various embodiments, analysis engine 145 performs one or more analyses based on the pre-injection information 510 and post-injection information 520 using one or more analyzers.

SQL analyzer 530, in various embodiments, performs a database analysis to determine the effects of injected faults on processing database requests. For example, if a database service 115 includes multiple database servers and one of them is down due to an injected fault, SQL analyzer 530 may determine, based on information 510 and 520, the response time for a request to be proceeded by the database service 115. SQL analyzer 530 may also determine whether the traffic to the database service 115 was rebalanced to the other database servers and whether the database servers could satisfy incoming demand with an acceptable response time, latency, and lag. Accordingly, SQL analyzer 530 may assess the effects of injected faults on a database service's ability to meet incoming demand while still complying with defined constraints. After completing its analysis, SQL analyzer 530 may present the results of the database analysis (as part of outcome 155) to a user. If SQL analyzer 530 determines that a particular aspect related to processing database requests did function as intended and is an anomaly (e.g., a response time was not under a particular time threshold), then SQL analyzer 530 generates an alert to inform the user, in various embodiments.

Connectivity analyzer 540, in various embodiments, performs a connectivity analysis to determine the effects of injected faults on connections between components (e.g., services 115). For example, an environment 110 may include a database service 115 and an application service 115 that is capable of establishing database connections with the database service 115 to issue queries. Accordingly, connectivity analyzer 540 may determine, based on information 510 and 520, whether there were any database connections that timed out and how long it took for those database connections to be reestablished. Connectivity analyzer 540 may determine impacts on the application service 115 that were caused by the database connection timeouts (e.g., how long it took for the application service 115 to receive a response to a query, whether the application service 115 had to return a timeout response to a user because their request could not be processed, whether the application service 115 correctly responded to the database connection timeouts, etc.).

As another example, if the fault affected a network component (e.g., a network router) and a portion of a service 115 became inaccessible, connectivity analyzer 540 may determine whether traffic was routed to another portion of that service 115 that could handle it and how long it took to start rerouting that traffic. Accordingly, connectivity analyzer 540 may assess the effects of injected faults on the communications between components in an environment 110. After completing its analysis, connectivity analyzer 540 may present the results of the connectivity analysis to a user. If connectivity analyzer 540 determines that a particular aspect related to connectivity did function as intended and is an anomaly (e.g., a connection timeout was not resolved within a certain amount of time), then connectivity analyzer 540 generates an alert to inform the user, in various embodiments.

Lock analyzer 550, in various embodiments, performs a lock analysis to determine the effects of injected faults on lock-based mechanisms of services 115. As an example, a database service 115 can execute database transactions in parallel that compete to read and write records for a database. In order to ensure correctness in the database, a transaction may acquire a lock on a database object (e.g., a row in a table) when performing database operations with respect to that database object—e.g., a first transaction may acquire an exclusive lock on a row before updating the row in order to prevent a second transaction from updating that row while the first transaction is updating it. Accordingly, lock analyzer 550 may determine, based on information 510 and 520, whether locks were provisioned/released in accordance with the lock protocols of the database service 115.

Consider an example in which a fault is injected that causes a database transaction of the database service 115 to become unresponsive. Lock analyzer 550 may determine whether a lock held by that transaction was released and how long it took for the lock to be released (if it was). If the fault affected a centralized component that tracks locks, lock analyzer 550 may determine whether that component recovered and may also determine if database transactions responded correctly when the centralized lock information was unavailable. Accordingly, lock analyzer 550 may assess the effects of injected faults on the lock mechanisms of components in an environment 110. After completing its analysis, lock analyzer 550 may then present the results of the lock analysis to a user. If lock analyzer 550 determines that a particular aspect of the lock mechanisms did function as intended and is an anomaly (e.g., the time to release a lock was greater than a defined threshold), then lock analyzer 550 generates an alert to inform the user, in various embodiments.

Log analyzer 560, in various embodiments, performs a log analysis based on log data to determine the effects of injected faults on components of an environment 110. That log data may be included in metric information 124 and include Splunk log data collected from various sources, such as databases, applications, and network devices. In various embodiments, the log data include various types of logs, such as event logs about system events, errors, warnings, and informational messages, transactions logs about transactions processed by applications, user activity logs about user actions, authentication logs about login attempts and accesses to resources, files, and systems, and traffic logs about network traffic, including Internet Protocol (IP) addresses, ports, and protocols.

Accordingly, log analyzer 560 may analyze the log data of information 510 and 520 to determine which events, errors, and warnings resulted from the injected faults. As an example, log analyzer 560 may determine that a set of transactions were rolled back due to a particular fault affecting a database server. As another example, log analyzer 560 may determine that an application failed at a certain point in its execution as particular function threw an error due to a certificate service 115 becoming unavailable because of a fault. After completing its analysis, log analyzer 560 may then present the results of the log analysis to a user. If log analyzer 560 determines that there was an anomaly (e.g., there was an unusual error), then log analyzer 560 generates an alert to inform the user, in various embodiments.

Correlation analyzer 570, in various embodiments, performs a correlation analysis to determine any correlations between components of an environment 110 based on a fault being injected into a particular one of those components. Accordingly, correlation analyzer 570 may determine, based on information 510 and 520, the “reach” that an injected fault had on components within an environment 110. For example, correlation analyzer 570 may determine that a fault injected in a storage service 115 caused an issue at a database service 115, which in turn caused an issue at a web service 115, and thus correlation analyzer 570 may determine that the fault reached or spread to the web service 115—there exists a correlation between the storage service 115 and the web service 115. After completing its analysis, correlation analyzer 570 may present the results of the log analysis to a user—e.g., a list of all the components affected and how they are correlated. If correlation analyzer 570 determines that there was an anomaly (e.g., a certain component should not have been affected), then correlation analyzer 570 generates an alert to inform the user, in various embodiments.

Analysis engine 145 can perform other analysis. In some embodiments, analysis engine 145 determines a restart count indicative of a number of containers 315 restarted as a result of one or more faults being injected into a set of services 115 and generates an alert in response to determining that the restart count is different than an expected restart count (e.g., the number of containers 315 after the faults have been injected is less than the number of containers 315 in an environment 110 before the faults have been injected). In various embodiments, analysis engine 145 determines, based on information 510 and 520, a time to recover for one or more services 115 affected by the injected faults and generates an alert based on the time to recover exceeding a time threshold. Analyses performed by analysis engine 145 may be used to gauge recovery time objective and recovery point objective of components within system 100.

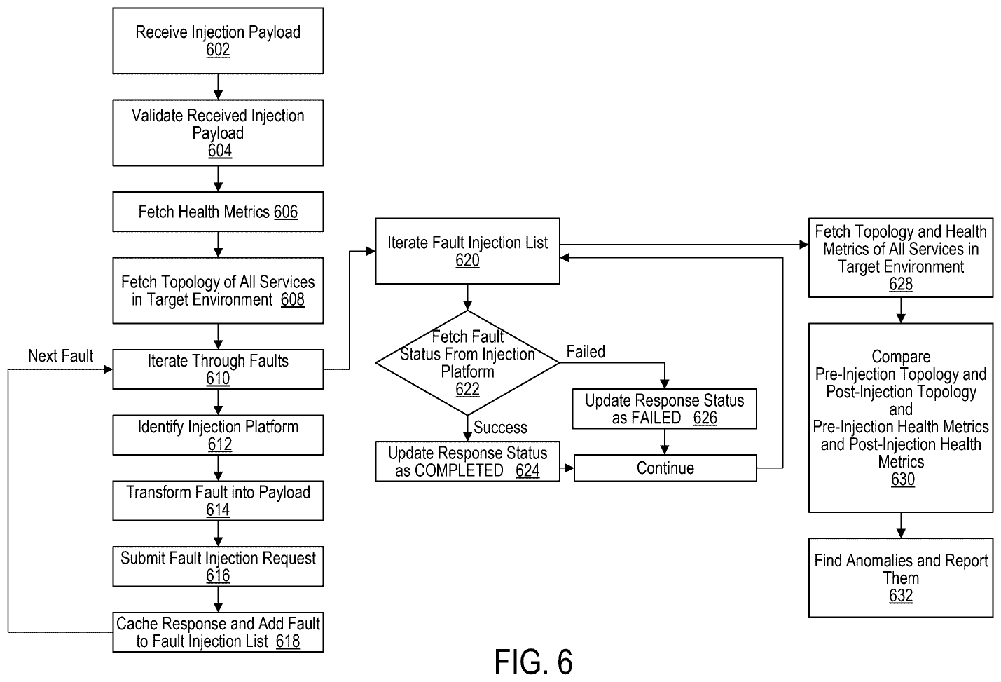

Turning now to FIG. 6, a block diagram of an example flow pertaining to injecting faults and assessing the effects of the faults on services 115 is shown. In various embodiments, this flow is implemented by orchestration platform 140. At step 602, an injection payload 150 that describes one or more faults to inject is received, and subsequently validated to ensure that the contents are correctly specified at step 604. At step 606, health metrics (e.g., at least a portion of metric information 124) of all services 115 of the target environment 110 are fetched from, e.g., database 120, and at step 608, the topology of all services 115 (e.g., at least a portion of topology information 126) of the target environment 110 is also fetched. In some cases, step 608 may be performed before step 606.

At step 610, an iterative process is performed to inject the one or more faults, where a given iteration involves steps 612, 614, 616, and 618. For a given fault, at step 612, an injection platform 130 that can inject the fault is identified. At step 614, the fault is transformed into a payload that can be ingested by the identified injection platform 130 and then a fault injection request 147 having the payload is submitted to the injection platform 130 at step 616. At step 618, a fault injection response 149 received from the injection platform 130 is cached and the fault is added to fault injection list 415. The flow then proceeds to the next iteration if there is another fault to inject; otherwise, the flow proceeds to step 620.

At step 620, an iterative process is performed to determine the statuses of the requested fault injections. For a fault injection on fault injection list 415, at step 622, the fault injection status of the fault injection is obtained from the appropriate injection platform 130. If the status indicates that the fault injection completed, then the flow proceeds to step 624. At step 624, the fault injection's status is updated to “completed.” But if the status indicates that the fault injection failed, then the flow proceeds to step 626 instead of step 624. At step 626, the fault injection's status is updated to “failed.” The flow then proceeds to the next iteration if there is another fault injection to check; otherwise, the flow proceeds to step 628.

At step 628, an updated version of the topology and health metrics of all services 115 of the target environment 110 is fetched. At step 630, the pre-injection topology is compared with the post-injection topology, and the pre-injection health metrics are compared with the post-injection health metrics. The topology and health metrics fetched at steps 606 and 608 correspond to the pre-injection health metrics and the pre-injection topology, and the topology and health metrics fetched at steps 628 correspond to the post-injection health metrics and the post-injection topology. At step 632, any anomalies are determined based on the comparisons of step 630 (e.g., if a certain service did not recover as evidenced by the topologies, then that may represent an anomaly) and then reported.

As an example, orchestration platform 140 may determine, based on the fetched health metrics and topology information, the health statuses for pods 310 of a particular service 115 and a number of containers 315. Orchestration platform 140 may inject a fault by terminating a set of VMs in a cloud zone having one or more of those pods 310. After collecting an updated version of the health metrics and topology information, orchestration platform 140 may then determine whether those pods 310 are healthy and a number of containers 315. If there are one or more unhealthy pods 310 or there is a mismatch between the numbers of containers 315, then orchestration platform 140 may throw an error.

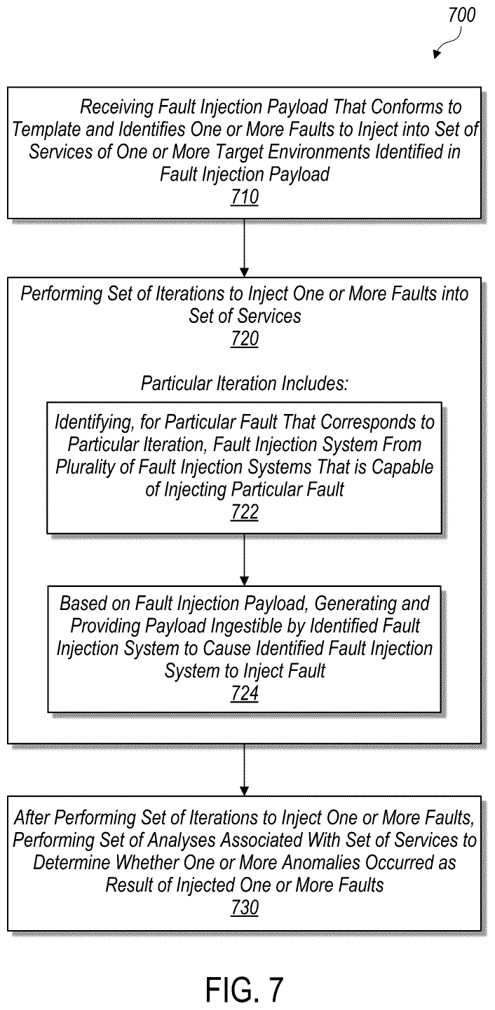

Turning now to FIG. 7, a flow diagram of a method 700 is shown. Method 700 is one embodiment of a method performed by a computer system (e.g., orchestration platform 140) to assess resilience of one or more services (e.g., services 115) through fault injections. Method 700 may be performed by executing program instructions stored on a non-transitory computer-readable medium. Method 700 may include more or fewer steps than shown. As an example, method 700 may include a step in which the computer system generates an alert in response to detecting an anomaly (e.g., a time to recover that is too long) after injecting faults into the one or more services.

Method 700 begins in step 710 with the computer system receiving a fault injection payload (e.g., an injection payload 150) that conforms to a template (e.g., template 200) and identifies one or more faults to inject into a set of services (e.g., services 115) of one or more target environments (e.g., environments 110) that are identified in the fault injection payload. The fault injection payload may specify one or more metrics (e.g., using metrics field 290) to collect and also one or more values for configurable variables (e.g., using variables fields 270), including a namespace variable, that affect an injection of the one or more faults into the set of services.

In some cases, the fault injection payload may specify one or more injection times at which to inject the one or more faults into the set of services. In some cases, the fault injection payload does not specify an injection time for injecting a particular fault and thus the computer system proceeds to provide an ingestible payload to an identified fault injection system to inject the particular fault without waiting until an injection time. In various embodiments, the set of services is distributed across multiple computer zones. A given computer zone may provide an isolated network of systems such that a particular failure (e.g., power outage) in the given computer zone does not cause the particular failure in other ones of the multiple computer zones.

In step 720, the computer system performs a set of iterations to inject the one or more faults into the set of services. In various embodiments, before performing the set of iterations, the computer system performs a validation operation to validate contents of the fault injection payload and returns an error in response to the injection payload failing to pass the validation operation. In step 722, for a particular one of the set of iterations, the computer system identifies a fault injection system from a plurality of fault injection systems that is capable of injecting, a particular fault that corresponds to the particular iteration. At least one of the one or more faults may be associated with another fault injection system than the identified fault injection system associated with the particular fault.

In step 724, for the particular iteration and based on the fault injection payload, the computer system generates and provides a payload ingestible by the identified fault injection system to cause the identified fault injection system to inject the fault. The particular iteration may further include the computer system updating a fault injection list (e.g., fault injection list 415) to indicate that the particular fault has been requested to be injected. After performing the set of iterations, the computer system may then issue, based on the fault injection list, a set of requests (e.g., fault injection status requests 430) to the fault injection system to determine statuses for faults that were requested to be injected by the fault injection system. A given one of the statuses may indicate whether a respective fault was successfully injected.

In step 730, after performing the set of iterations to inject the one or more faults, the computer system performs a set of analyses associated with the set of services to determine whether one or more anomalies occurred as a result of the injected one or more faults. Before performing the set of iterations, the computer system may collect topology information (e.g., topology information 126) describing a topology of the set of services and metric information (e.g., metric information 124) describing a set of metrics associated with the set of services. The set of metrics can include log records generated by a database service of the set of services. After performing the set of iterations, the computer system may determine a time to recover for one or more of the set of services based on the collected topology and metric information and an updated version of the topology and metric information acquired after the one or more faults have been injected into the set of services. In some cases, the computer system generates an alert based on the time to recover exceeding a time threshold.

In some cases, the set of services includes a database service and an application service capable of establishing a database connection with the database service. Accordingly, the set of analyses may include a connection analysis to determine whether the database connection timed out and to determine any impacts on the application service caused by a time out of the database connection. The computer system may present a result of the connection analysis to a user. In some cases, the set of analyses includes a lock analysis to determine whether locks were allocated and deallocated in accordance with one or more lock procedures for services affected by the one or more faults. The computer system may also present a result of the lock analysis to the user. The set of analyses may include a query analysis to determine a response time associated with processing a query sent by the application service to the database service. In various embodiments, the set of services is implemented by software containers deployed into the one or more target environments. Accordingly, the computer system may determine a restart count indicative of a number of software containers restarted as a result of the one or more faults being injected into the set of services and further generate an alert in response to determining that the restart count is different than an expected restart count.

### Exemplary Computer System

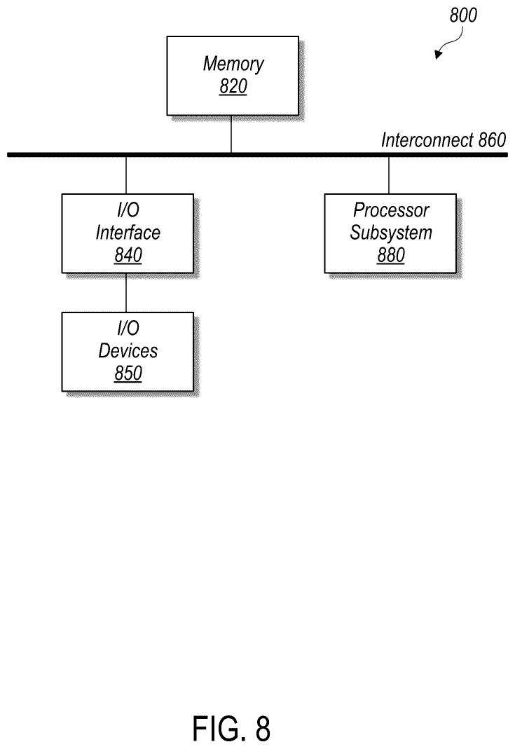

Turning now to FIG. 8, a block diagram of an exemplary computer system 800, which may implement system 100, a service 115, database 120, an injection platform 130, and orchestration platform 140, is depicted. Computer system 800 includes a processor subsystem 880 that is coupled to a system memory 820 and I/O interfaces(s) 840 via an interconnect 860 (e.g., a system bus). I/O interface(s) 840 is coupled to one or more I/O devices 850. Although a single computer system 800 is shown in FIG. 8 for convenience, system 800 may also be implemented as two or more computer systems operating together.

Processor subsystem 880 may include one or more processors or processing units. In various embodiments of computer system 800, multiple instances of processor subsystem 880 may be coupled to interconnect 860. In various embodiments, processor subsystem 880 (or each processor unit within 880) may contain a cache or other form of on-board memory.

System memory 820 is usable store program instructions executable by processor subsystem 880 to cause system 800 perform various operations described herein. System memory 820 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 800 is not limited to primary storage such as memory 820. Rather, computer system 800 may also include other forms of storage such as cache memory in processor subsystem 880 and secondary storage on I/O Devices 850 (e.g., a hard drive, storage array, etc.). In some embodiments, these other forms of storage may also store program instructions executable by processor subsystem 880. In some embodiments, program instructions that when executed implement analysis engine 145, payload parser 320, state collector 330, injection requester 410, and/or an injection agent 420 may be included/stored within system memory 820.

I/O interfaces 840 may be any of various types of interfaces configured to couple to and communicate with other devices, according to various embodiments. In one embodiment, I/O interface 840 is a bridge chip (e.g., Southbridge) from a front-side to one or more back-side buses. I/O interfaces 840 may be coupled to one or more I/O devices 850 via one or more corresponding buses or other interfaces. Examples of I/O devices 850 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 800 is coupled to a network via a network interface device 850 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a computer system, a fault injection payload that conforms to a template and identifies one or more faults to inject into a set of services of one or more target environments that are identified in the fault injection payload;
performing, by the computer system, a set of iterations to inject the one or more faults into the set of services, wherein a particular one of the iterations includes:
identifying, for a particular fault that corresponds to the particular iteration, a fault injection system from a plurality of fault injection systems that is capable of injecting the particular fault; and
based on the fault injection payload, generating and providing a payload ingestible by the identified fault injection system to cause the identified fault injection system to inject the fault; and
after performing the set of iterations to inject the one or more faults, the computer system performing a set of analyses associated with the set of services to determine whether one or more anomalies occurred as a result of the injected one or more faults.

2. The method of claim 1, further comprising:
before performing the set of iterations, the computer system collecting topology information describing a topology of the set of services and metric information describing a set of metrics associated with the set of services;
after performing the set of iterations, the computer system determining a time to recover for one or more of the set of services based on the topology information and the metric information and an updated version of the topology information and the metric information acquired after the one or more faults have been injected into the set of services; and
generating, by the computer system, an alert based on the time to recover exceeding a time threshold.

3. The method of claim 1, wherein the particular iteration further includes updating a fault injection list to indicate that the particular fault has been requested to be injected, and wherein the method further comprises:
after performing the set of iterations, the computer system issuing, based on the fault injection list, a set of requests to the fault injection system to determine statuses for faults requested to be injected by the fault injection system, wherein a given one of the statuses indicates whether a respective fault was successfully injected.

4. The method of claim 1, wherein at least one of the one or more faults is associated with another fault injection system than the identified fault injection system associated with the particular fault.

5. The method of claim 1, wherein the fault injection payload specifies one or more injection times at which to inject the one or more faults into the set of services.

6. The method of claim 1, wherein the providing of the ingestible payload to the identified fault injection system to inject the particular fault is performed without waiting until an injection time in response to determining that the fault injection payload does not specify the injection time at which to inject the particular fault into the set of services.

7. The method of claim 1, wherein the fault injection payload specifies one or more metrics to collect and one or more values for configurable variables, including a namespace variable, that affect an injection of the one or more faults into the set of services.

8. The method of claim 1, wherein the set of services includes a database service and an application service capable of establishing a database connection with the database service, wherein the set of analyses includes a connection analysis to determine whether the database connection timed out and to determine impacts on the application service caused by a time out of the database connection, and wherein the method further comprises the computer system presenting a result of the connection analysis to a user.

9. The method of claim 1, wherein the set of analyses includes a lock analysis to determine whether locks were allocated and deallocated in accordance with one or more lock procedures for services affected by the one or more faults, and wherein the method further comprises the computer system presenting a result of the lock analysis to a user.

10. The method of claim 1, wherein the set of services is distributed across multiple computer zones, wherein a given computer zone provides an isolated network of systems such that a particular failure in the given computer zone does not cause the particular failure in other ones of the multiple computer zones.

11. The method of claim 1, wherein the set of metrics includes log records generated by a database service of the set of services.

12. A non-transitory computer-readable medium having program instructions stored thereon that are capable of causing a computer system to perform operations comprising:
receiving a fault injection payload that conforms to a template and identifies one or more faults to inject into a set of services of one or more target environments that are identified in the fault injection payload;
performing a set of iterations to inject the one or more faults into the set of services, wherein a particular one of the iterations includes:
identifying, for a particular fault that corresponds to the particular iteration, a fault injection system from a plurality of fault injection systems that is capable of injecting the particular fault; and
based on the fault injection payload, generating and providing a payload ingestible by the identified fault injection system to cause the identified fault injection system to inject the fault; and
after performing the set of iterations to inject the one or more faults, performing a set of analyses associated with the set of services to determine whether one or more anomalies occurred as a result of the injected one or more faults.

13. The non-transitory computer-readable medium of claim 12, wherein the set of services includes a database service and an application service capable of sending queries to the database service, wherein the set of analyses includes a query analysis to determine a response time associated with processing a query sent by the application service to the database service;
and wherein the operations further comprise presenting a result of the query analysis to a user.

14. The non-transitory computer-readable medium of claim 12, wherein the operations further comprise:
determining a time to recover for one or more of the set of services after performing the set of iterations; and
generating an alert in response to determining that the time to recover is greater by a threshold amount of time than a time to recover for a previous software version of the one or more services.

15. The non-transitory computer-readable medium of claim 12, wherein the set of services is implemented by software containers deployed into the one or more target environments, and wherein the operations further comprise:
determining a restart count indicative of a number of software containers restarted as a result of the one or more faults being injected into the set of services; and
generating an alert in response to determining that the restart count is different than an expected restart count.

16. The non-transitory computer-readable medium of claim 12, wherein the operations further comprise:
before performing the set of iterations, performing a validation operation to validate contents of the fault injection payload; and
returning an error in response to the fault injection payload failing to pass the validation operation.

17. A system, comprising:
at least one processor; and
memory having program instructions stored thereon that are executable by the at least one processor to cause the system to perform operations comprising:
receiving a fault injection payload that conforms to a template and identifies one or more faults to inject into a set of services of one or more target environments that are identified in the fault injection payload;
performing a set of iterations to inject the one or more faults into the set of services, wherein a particular one of the iterations includes:
identifying, for a particular fault that corresponds to the particular iteration, a fault injection system from a plurality of fault injection systems that is capable of injecting the particular fault; and
based on the fault injection payload, generating and providing a payload ingestible by the identified fault injection system to cause the identified fault injection system to inject the fault; and
after performing the set of iterations to inject the one or more faults, performing a set of analyses associated with the set of services to determine whether one or more anomalies occurred as a result of the injected one or more faults.

18. The system of claim 17, wherein the operations further comprise:
before performing the set of iterations, collecting topology information describing a topology of the set of services and metric information describing a set of metrics associated with the set of services;
after performing the set of iterations, determining a time to recover for one or more of the set of services based on the topology information and the metric information and an updated version of the topology information and the metric information acquired after the one or more faults have been injected into the set of services; and
generating an alert based on the time to recover exceeding a time threshold.

19. The system of claim 17, wherein the fault injection payload specifies one or more injection times at which to inject the one or more faults into the set of services.

20. The system of claim 17, wherein the set of services is implemented by software containers deployed into the one or more target environments, and wherein the operations further comprise:
determining a restart count indicative of a number of software containers restarted as a result of the one or more faults being injected into the set of services; and
generating an alert in response to determining that the restart count is different than an expected restart count.
